(19) United States
(12) Patent Application Publication
(10) Pub. No.: US 2025/0304032 A1
(43) Pub. Date: Oct. 2, 2025

(54) METHOD FOR APPROXIMATING A COEFFICIENT OF FRICTION

(71) Applicant: ZF CV Systems Global GmbH, Bern (CH)

(72) Inventors: Benjamin Bieber, Wedemark (DE); Jonas Böttcher, Hannover (DE); Klaus Plähn, Seelze (DE); Oliver Wulf, Neustadt (DE)

(21) Appl. No.: 19/235,460

(22) Filed: Jun. 11, 2025

Related U.S. Application Data
(63) Continuation of application No. PCT/EP2023/083321, filed on Nov. 28, 2023.

(30) Foreign Application Priority Data
Dec. 20, 2022 (DE) 10 2022 134 156.9

(51) Int. Cl. B60W 30/02; B60W 40/068; B60W 50/00; B60W 50/14; B60W 60/00

(52) U.S. Cl. CPC B60W 30/02; B60W 40/068; B60W 50/0097; B60W 50/14; B60W 60/001; B60W 2510/20; B60W 2530/10; B60W 2530/201; B60W 2552/40

(57) ABSTRACT

A method for approximating a coefficient of friction includes: determining a trajectory of the vehicle for a driving situation; determining a steering angle expected value; determining a steering angle actual value, which is set on the vehicle in the driving situation; determining a vehicle position of the vehicle in the driving situation; determining a manipulated variable deviation between the steering angle expected value and the steering angle actual value, and/or determining a setpoint-actual deviation between the vehicle position during the driving situation and the trajectory; and, approximating the coefficient of friction based on the determined manipulated variable deviation and the determined setpoint-actual deviation. A driver assistance system is configured to perform the method. A vehicle includes the driver assistance system. A computer program product is configured to cause the method to be performed.

### CROSS-REFERENCE TO RELATED APPLICATIONS

This application is a continuation application of international patent application PCT/EP2023/083321, filed Nov. 28, 2023, designating the United States and claiming priority from German application 10 2022 134 156.9, filed Dec. 20, 2022, and the entire content of both applications is incorporated herein by reference.

### TECHNICAL FIELD

The disclosure relates to a method for approximating a coefficient of friction between wheels of a vehicle and a roadway. Furthermore, the disclosure relates to a driver assistance system, a vehicle, and a computer program product.

### BACKGROUND

The capacity of a vehicle to change its velocity or direction substantially depends on the forces which the tires of the vehicle can transmit to a roadway. The most important influencing variable for the transmittable forces is the coefficient of friction between the road and the tires of the vehicle. This coefficient of friction is influenced by the set of tires of the vehicle and by properties of the roadway. In particular the roadway properties can vary significantly in the course of a journey.

A human driver assesses the roadway conditions visually through a windshield of the vehicle and/or acoustically by way of rolling noises of the wheels of the vehicle on the roadway. For this purpose, a human driver uses experience and knowledge about a current set of tires and a steering behavior of the vehicle and additionally takes into consideration current weather conditions. The current coefficient of friction is essential for safe vehicle control, since the driving style can be adjusted with the aid of this information in that the intended vehicle movement is compared to the actual vehicle movement. An experienced motor vehicle driver thus continuously assesses which longitudinal and lateral accelerations are possible without hazard for the vehicle. For correct assessment of the forces transmittable to the roadway for the control of the vehicle and therefore also the possible movement changes of the vehicle, long-time experience is indispensable. In particular unpracticed drivers can incorrectly assess the coefficient of friction between the wheels of the vehicle and the roadway, due to which there is a significant risk of accident. A reliable assessment of the coefficient of friction is also important for safe operation of the vehicle in autonomous vehicles.

Sensor-based approaches for automated assessment of roadway conditions are known. Thus, for example, optical sensors are available, which optically capture a roadway located in front of the vehicle and evaluate the optically captured image data to assess adhesion conditions between the tires of the vehicle and the roadway. However, these sensors have multiple disadvantages. First, the results are strongly influenced by the properties of the sensor and are not usable in all driving situations under certain circumstances. Thus, for example, systems which use conventional cameras can only be used during the day due to poor light conditions. Furthermore, optical systems only take into consideration aspects of the roadway and neglect vehicle-specific aspects.

### SUMMARY

The object of the present disclosure is to specify a method for approximating a coefficient of friction between wheels of a vehicle and a roadway, a driver assistance system, a vehicle, and/or a computer program product which is preferably improved with respect to an accuracy of the approximation, enables improved safety, and/or is reliably usable.

In a first aspect, the disclosure achieves the object via a method for approximating a coefficient of friction between wheels of a vehicle in a current vehicle configuration and a roadway, wherein the method includes the following steps: determining a trajectory of the vehicle for a driving situation; determining a steering angle expected value, which is a predicted value of a steering angle which is to be set on the vehicle in order to follow the trajectory; determining a steering angle actual value which is set in the driving situation on the vehicle; determining a vehicle position of the vehicle in the driving situation; determining a manipulated variable deviation between the steering angle expected value and the steering angle actual value, and/or determining a setpoint-actual deviation between the vehicle position during the driving situation and the trajectory; and approximating the coefficient of friction based on the determined manipulated variable deviation and/or the determined setpoint-actual deviation.

The disclosure is based on the finding that the steering angle which has to be modulated on the vehicle in order to follow a trajectory corresponds to the coefficient of friction between the wheels of the vehicle and the roadway. A change of the vehicle dynamics caused by the steering, in particular a change of the yaw rate of the vehicle, is thus dependent on forces which can be transmitted between the vehicle and the roadway traveled by the vehicle. At a low coefficient of friction, the transmittable forces are generally also low and an achievable change of the vehicle dynamics can be reduced. At a high coefficient of friction, high forces are also transmittable, so that strong changes of the vehicle dynamics can be achieved. Accordingly, different steering angles can be necessary for different coefficients of friction in order to follow an otherwise identical trajectory. If the steering angle is not adapted to the current coefficient of friction, in contrast, the vehicle cannot follow the trajectory under certain circumstances and deviations occur between the actual vehicle position of the vehicle and the trajectory. Furthermore, greater steering angles than expected can be necessary in order to follow the trajectory. The disclosure makes use of this finding in order to approximate the current coefficient of friction based on the determined manipulated variable deviation and the determined setpoint-actual deviation. The method preferably includes determining at least one load characteristic. The coefficient of friction is particularly preferably additionally approximated based on the determined load characteristic. The method permits a very simple, cost-effective, and/or rapid approximation of the coefficient of friction, since the approximation is based on deviations between expected values and variables actually occurring during the driving situation.

The coefficient of friction determines the maximum forces transmittable between vehicle and roadway. The driving situation is preferably a steering situation of the vehicle, thus a situation in which the position of the wheels of the vehicle, the alignment of the vehicle, and/or the yaw rate of the vehicle changes. For example, the driving situation is a cornering operation of a vehicle or a segment of a cornering operation. The driving situation is not a discrete point in time, but rather a period of time. The driving situation includes at least one period of time which is necessary to achieve an effect on the vehicle position by setting a steering angle actual value.

The trajectory includes at least one planned path (setpoint path), which is to be traveled by the vehicle to fulfill the driving task. For example, the trajectory includes at least one path curve for a cornering operation, along which the vehicle is to drive through the curve. Furthermore, the trajectory preferably includes a driving-dynamics specification. This driving-dynamics specification is or preferably includes a velocity specified for traveling the path or a predetermined velocity course. The trajectory is planned before the actual driving situation for the driving situation, thus preferably describes a setpoint value of the vehicle movement for the driving situation. The trajectory is preferably determined by a fully autonomous or semiautonomous unit, such as an automatic distance control or an autonomous control unit, which is also referred to as a virtual driver.

The steering angle actual value is a steering angle actually modulated on the vehicle in the driving situation. The steering angle actual value is thus, for example, the value of a steering angle of the wheels of the vehicle which is modulated on the wheels in the context of a cornering operation. The steering angle actual value can also be, however, a course of the steering angle actual value or a plurality of chronologically successive steering angle actual values in the driving situation. The steering angle expected value is the value of the steering angle which has to be provided according to a prediction by a steering system of the vehicle in order to follow the trajectory provided for a driving situation. The steering angle expected value is thus a value of the steering angle or a course of this value which is to be set according to a prediction on the vehicle so that the vehicle follows the trajectory. Thus, for example, a steering angle expected value of 15° can be predicted for a curved path of the trajectory before the vehicle actually travels the path.

The setpoint-actual deviation is a deviation between the actual position of the vehicle during the driving situation (the vehicle position) and the position of the vehicle on the path desired according to the trajectory. For example, due to a reduced coefficient of friction, a provided steering angle can be too low to follow the trajectory so that the vehicle is carried toward the outside of the curve out of a curve to be traveled. In this case, a setpoint-actual deviation results between the vehicle position and the position of the vehicle on the trajectory or its path.

In a first embodiment of the method, the setpoint-actual deviation is or includes a transverse offset of the vehicle from a path included by the trajectory. The transverse offset is an offset of the vehicle or the vehicle position from the path transversely to the direction of travel of the vehicle. For an understeering vehicle, such a transverse offset is typically directed toward the outside of the curve. A transverse offset of the vehicle from the trajectory is particularly critical since a transverse offset toward the center of the road can result in collisions with oncoming vehicles, while a transverse offset toward the outer side of the road can have the result that the vehicle drives off the roadway.

The setpoint-actual deviation preferably is or includes a directional error of the vehicle in relation to a setpoint alignment of the vehicle included by the trajectory. The setpoint alignment is an alignment of the vehicle provided in the scope of the trajectory, which is preferably defined with reference to the path. In general, the setpoint alignment is selected so that the front of the vehicle points in the direction of the path. The directional error is preferably a course angle error between a setpoint course angle included by the trajectory and an actual course angle existing in the driving situation. A directional error is a strong indication of an existing or building vehicle-dynamics instability of the vehicle and is therefore particularly suitable for approximating the coefficient of friction. For example, an understeering vehicle or its longitudinal axis encloses a sideslip angle with a tangent on the path, since the yaw rate of the vehicle is too low to guide the vehicle along the required path. In contrast, in the case of oversteering, the yaw rate of the vehicle is too high, so that the vehicle turns more strongly into the curve than intended. Accordingly, a directional error of the vehicle also results upon oversteering.

In an embodiment, the coefficient of friction is only approximated if both a manipulated variable deviation and a setpoint-actual deviation exist. The method can thus be performed particularly robustly.

The determination of a manipulated variable deviation between the steering angle expected value and the steering angle actual value preferably only takes place if the steering angle actual value during the driving situation lies within a steering angle tolerance around the steering angle expected value. Preferably, the determination of a setpoint-actual deviation between the vehicle position during the driving situation and the trajectory only takes place if the vehicle position during the driving situation lies within a position tolerance around the trajectory. Any measurement errors can be compensated for by the position tolerance and/or the steering angle tolerance.

The method preferably furthermore includes: performing trajectory planning to obtain the trajectory. The trajectory planning is particularly preferably performed using the load characteristic. The trajectory is intended to fulfill a driving task, such as an autonomous journey from point A to point B. In the context of the trajectory planning, at least the planned path which is to be traveled by the vehicle to fulfill the driving task is planned. The trajectory preferably furthermore includes a driving-dynamics specification. This driving-dynamics specification preferably is or includes a predetermined velocity or a predetermined velocity course for traveling the path. The trajectory planning is preferably performed based on environmental information, which is preferably provided by various environmental sensors of the vehicle. The vehicle can thus include a camera, for example, which captures an environment located in front of the vehicle in the direction of travel. The trajectory to be traveled is then planned on the basis of the environmental information provided by the camera. According to various embodiments of the method, the load characteristic is taken into consideration in the trajectory planning. For example, a setpoint velocity of the vehicle included by the trajectory, at which the vehicle travels the path, can be planned as a function of a weight of the vehicle, wherein higher setpoint velocities are planned at lower vehicle weight than at high vehicle weight. Furthermore, the velocity intended for traveling the path can be restricted, for example, to 60 km/h at high vehicle weight, although a velocity of 80 km/h is permitted according to the traffic laws on the road to be traveled. The trajectory planning is preferably performed using map data. The trajectory planning can also be performed without environmental information, in particular using map data. The trajectory planning preferably only takes place without environmental information or information which is obtained by environmental perception if it can be excluded that dynamic objects (people, things, et cetera) are located on the trajectory.

The determination of the steering angle expected value is preferably performed using the load characteristic. For this purpose, the method preferably includes determining at least one load characteristic of the current vehicle configuration. The actual steering capacity of the vehicle depends on, among other things, its weight and weight distribution. Thus, for example, inertial forces to be overcome when traveling a curve can be greater the heavier the vehicle is. A steering angle to be set on a vehicle having more than two axles is therefore larger under certain circumstances with identical path and identical velocity of the vehicle for a heavy vehicle than for a light vehicle. A location of a center of gravity of the vehicle also has an influence on its tendency to change the direction. By taking into consideration the load characteristic when determining the steering angle expected value, such effects are at least partially incorporated into the approximation. A quality of the approximation can be improved.

According to an embodiment, the steering angle expected value is determined based on a curvature of the trajectory and a wheelbase of the vehicle, a number of axles of the vehicle, and/or a steerability of axles of the vehicle. The determination of the steering angle expected value is then also based on, in addition to the aspect of the curvature of the trajectory relating to the driving task, at least one vehicle-specific aspect. For example, vehicles having a small wheelbase can generally travel tighter curves than vehicle having large wheelbase. The determined steering angle expected value can preferably be predicted with increased accuracy by taking into consideration the wheelbase of the vehicle, the number of axles of the vehicle, and/or the steerability of axles of the vehicle. A quality of the approximation of the coefficient of friction can thus also be improved if the approximation is performed based on the manipulated variable deviation. The curvature of the trajectory is preferably a curvature of the path.

The method preferably furthermore includes: monitoring the setpoint-actual deviation, wherein the setpoint-actual deviation is continuously determined or is determined at multiple successive points in time during the monitoring; and determining a trajectory deviation rate of change based on the setpoint-actual deviations determined during the monitoring. The trajectory deviation rate of change specifies the change over time of the setpoint-actual deviation, thus the deviation of the vehicle position from the trajectory. The trajectory deviation rate of change preferably describes the change of the trajectory deviation over a specific period of time in relation to the duration of this period of time. The observed period of time is preferably short. The duration of the period of time is preferably 10 seconds or less, preferably 8 seconds or less, preferably 6 seconds or less, preferably 5 seconds or less, preferably 4 seconds or less, preferably 3 seconds or less, preferably 2 seconds or less, preferably 1 second or less. An increasing setpoint-actual deviation is an indication that an unstable driving status exists. An increasing trajectory deviation rate of change exists, for example, when the vehicle understeers during a cornering operation and as a result a transverse offset of the vehicle continuously increases. The determination of the trajectory deviation rate of change permits particularly easy early detection of deviations of an actual movement of the vehicle from a setpoint movement according to the trajectory. Proceeding from a state in which the vehicle travels on the path, the occurrence of a small setpoint-actual deviation already causes an increasing trajectory deviation rate of change. A trajectory deviation rate of change can thus be determined even with small absolute setpoint-actual deviation.

In an embodiment, the approximation of the coefficient of friction only takes place if the trajectory deviation rate of change characterizes an increasing setpoint-actual deviation of the vehicle position from the trajectory. The approximation of the coefficient of friction becomes more robust and a risk of an erroneous determination is minimized. For example, setpoint-actual deviations may not be considered for the approximation of the coefficient of friction which result solely from the vehicle entering a curve already having a transverse offset to the path, but then following the curve stably with uniform transverse offset to the path. Analogously, for example, manipulated variable deviations are not considered which result from the steering angle being increased to reduce the transverse offset, since the trajectory deviation rate of change characterizes a decreasing setpoint-actual deviation in this case.

In a variant of the method, the coefficient of friction is approximated using a learned reference coefficient of friction. The coefficient of friction can also be approximated using multiple learned reference coefficients of friction. The learned reference coefficients of friction can be coefficients of friction approximated for driving situations chronologically upcoming in the driving situation, for example. Thus, for example, in a chronologically upcoming reference driving situation, a reference coefficient of friction can have been approximated for a substantially identical load characteristic and a comparable path, which is then used in the driving situation for approximating the current coefficient of friction. If, for example, the reference coefficient of friction was learned for a wet roadway (that is, reduced coefficient of friction), then a manipulated variable deviation which characterizes a steering angle actual value which is less than the steering angle expected value can indicate a current coefficient of friction with dry roadway. The current coefficient of friction is preferably approximated as a multiple of the reference coefficient of friction, wherein a multiplier used is proportional to the manipulated variable deviation.

The method preferably furthermore includes: detecting a control system intervention of a stability control system of the vehicle; determining a coefficient of friction using control system data which are provided by the stability control system; wherein the coefficient of friction is alternatively or additionally approximated based on the coefficient of friction if a control system intervention is detected. The stability control system is preferably a stability control system of the vehicle, in particular a so-called electronic stability control (ESC) and/or an antilock braking system (ABS) of the vehicle. Such stability control systems are provided in nearly all modern vehicles. Stability control systems determine a variety of control system data, which permits conclusions about the coefficient of friction or directly represent the coefficient of friction, in case of a control system intervention. The disclosure makes use of this in the embodiment.

According to an embodiment, the method furthermore includes: performing at least one following operation using the approximated coefficient of friction, wherein the following operation is or includes providing a warning signal, setting a stability control system into a preventative regulation mode; redetermining the trajectory of the vehicle, determining a movement degree of freedom limiting value, limiting a movement degree of freedom of the vehicle, and/or validating a coefficient of friction sensor. The following operation is preferably only performed if the approximated coefficient of friction falls below a coefficient of friction limiting value. A warning signal can thus only be output if the coefficient of friction falls below the coefficient of friction limiting value. This can be the case, for example, when the vehicle drives on an icy roadway. The warning signal is preferably an optical, acoustic, and/or haptic warning signal. However, it can also be provided that the warning signal is an electrical warning signal which is provided at a control unit of the vehicle. The redetermination of the planned trajectory can be a complete redetermination of the planned trajectory, a partial redetermination of the planned trajectory, and/or update of the planned trajectory. A partial redetermination is provided, for example, when a path curve included by the planned trajectory or a path included by the trajectory is maintained and at the same time a corresponding velocity profile for traveling the path curve, which is included by the planned trajectory, is redetermined. In the partial redetermination, preferably all information and/or data underlying the trajectory planning are determined again. In updating, preferably only some of the information and/or data underlying the trajectory planning are determined again. The determined coefficient of friction and/or the determined driving dynamics limiting value is/are preferably taken into consideration in the trajectory, wherein a level of safety when using the vehicle can be increased. Observing the driving dynamics limiting value ensures a safe and stable journey of the vehicle in normal operation. The driving dynamics limiting value preferably is or includes a maximum permitted vehicle velocity, a maximum permitted transverse acceleration, a maximum permitted vehicle acceleration, a maximum permitted vehicle deceleration, a maximum permitted steering angle gradient, a maximum permitted steering frequency, or a minimum permitted curve radius of the vehicle. The coefficient of friction sensor is preferably an optical and/or acoustic coefficient of friction sensor.

In a second aspect, the disclosure achieves the object stated at the outset using a driver assistance system which is configured to carry out the method according to the first aspect of the disclosure. The driver assistance system preferably includes a control unit and an interface which can be connected to a vehicle network of the vehicle. The interface is preferably configured to receive vehicle signals which represent at least the load characteristic, the trajectory, the steering angle expected value, the steering angle actual value, and/or the manipulated variable deviation. It is to be understood that one or more of the determination steps of the method can be performed by the driver assistance system based on such vehicle signals. The driver assistance system thus, for example, does not have to directly determine the load characteristic itself, but rather can also determine this based on load signals, for example, which are provided by an air suspension system of the vehicle on the vehicle network.

In a third aspect, the disclosure achieves the object stated at the outset by way of a vehicle having at least two axles, an autonomous unit, a steering system, and a driver assistance system according to the second aspect of the disclosure.

According to a fourth aspect of the disclosure, the object mentioned at the outset is achieved via a computer program product which has program code means that are stored on a computer-readable data carrier in order to carry out the method according to the first aspect of the disclosure when the computer program product is executed on a computing unit, in particular the control unit of the driver assistance system according to the second aspect of the disclosure.

It is to be understood that the driver assistance system according to the second aspect of the disclosure, the vehicle according to the third aspect of the disclosure, and the computer program product according to the fourth aspect of the disclosure have identical and similar sub-aspects, as are set forth in particular in the dependent claims for the method according to the first aspect of the disclosure.

### BRIEF DESCRIPTION OF DRAWINGS

The invention will now be described with reference to the drawings wherein:

FIG. 1 shows a top view of a schematically illustrated vehicle;

FIG. 2 shows a driving situation of the vehicle from FIG. 1 illustrated as a cornering operation;

FIG. 3 shows a driving situation of the vehicle from FIG. 1 illustrated as a cornering operation, wherein the vehicle understeers;

FIG. 4 shows a schematic flow chart of a method for approximating a coefficient of friction; and,

FIG. 5 shows a diagram which illustrates a course of a steering angle actual value, a steering angle expected value, a curvature of a path, a transverse offset of the vehicle, and a directional error of the vehicle for a driving situation.

### DETAILED DESCRIPTION

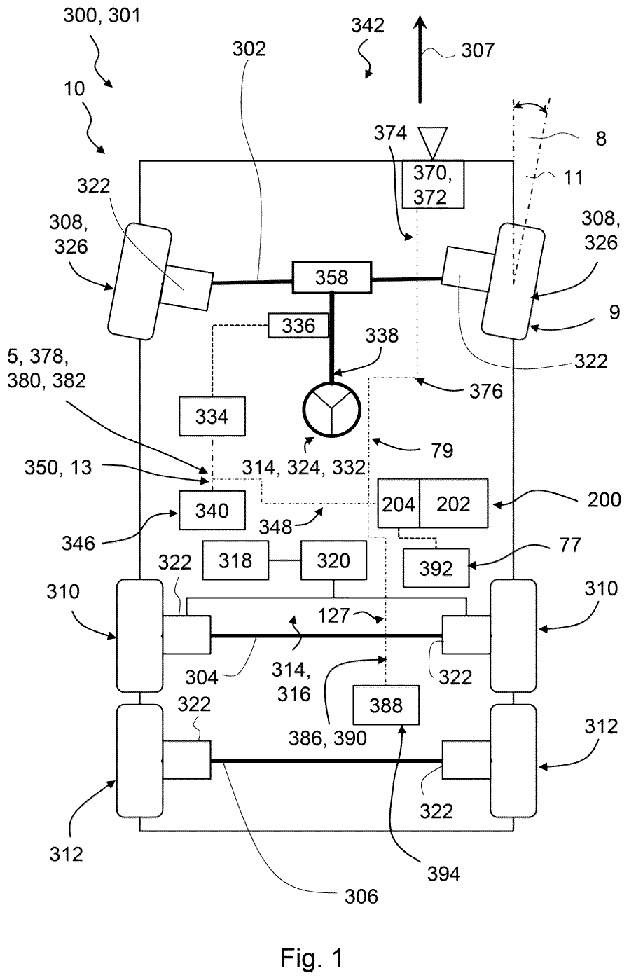

FIG. 1 shows a vehicle 300, which is configured as a three-axle utility vehicle 301. The vehicle 300 includes, in addition to a front axle 302 and a rear axle 304, a liftable auxiliary axle 306, which trails the rear axle 304 in the direction of travel 307. The liftable auxiliary axle 306 (lift axle 306 in short) can be raised or lifted so that the mass of the vehicle 300 or a weight force resulting from the load is distributed only onto front wheels 308 of the front axle 302 and rear wheels 310 of the rear axle 304. When the lift axle 306 is lowered, the weight force of the vehicle 300 is additionally distributed onto auxiliary wheels 312 of the lift axle 306.

The vehicle 300 includes multiple vehicle actuators 314, which are configured to influence the vehicle 300 in its longitudinal dynamics and transverse dynamics. For this purpose, the vehicle actuators 314 influence multiple movement degrees of freedom of the vehicle 300. A braking system 316 is provided for braking the vehicle 300, which includes a brake control unit 318, a brake modulator 320, and multiple brake actuators 322. The brake actuators 322 are assigned to the wheels 308, 310, 312 of the vehicle 300 and are configured to provide a braking torque at the wheels 308, 310, 312. For reasons of illustration, only the brake actuators 322 of the rear wheels 310 are connected to the brake modulator 320 in FIG. 1. To brake the vehicle 300, the brake module 320 provides a brake pressure at the brake actuators 322, which thereupon modulate a brake slip at the wheels 308, 310, 312 of the vehicle 300. The brake system 316 is an electronically controllable brake system 316 which can be controlled based on electrical signals. A motor (not shown in the figures) is provided for further influence of longitudinal dynamics of the vehicle 300.

As a further vehicle actuator 314, the vehicle 300 includes a steering system 324. The steering system 324 is configured to control steered wheels 326 of a steerable axle of the vehicle 300 or to modulate a steering angle 8 at the steered wheels 326. In the utility vehicle 301 according to FIG. 1, the front axle 302 represents the steerable axle, so that the front wheels 308 are the steered wheels 326. However, for example, it can also be provided that the auxiliary wheels 312 of the auxiliary axle 306 are steerable, wherein the auxiliary axle 312 is then usually not liftable.

The steering system 324 is an active steering system 332 here, thus an at least partially electronic steering system 332. The setting of the steering angle 8 at the steered wheels 326 does not take place solely mechanically in the active steering system 332, but rather at least partially based on electrical signals. For this purpose, the active steering system 332 includes a steering control unit 334, which is connected to a servomotor 336. The servomotor 336 is arranged on a steering column 338 of the steering system 324 and is configured to provide a steering torque at the steering column 338. For example, an output shaft (not shown in the figures) of the servomotor 336 is connected for this purpose to the steering column 338 via a gearing.

The vehicle 300 is configured in the embodiment shown to drive autonomously. The vehicle 300 is thus not controlled by a human driver, but rather preferably completely by an autonomous unit 340, which is also referred to as a virtual driver 340. The autonomous unit 340 is configured to carry out a trajectory planning 55 in order to obtain a trajectory 5 of the vehicle 300 in a driving situation 3. In the present embodiment, the trajectory 5 includes a path 7 to be traveled by the vehicle 300. The path 7 is a movement path which the vehicle 300 is supposed to follow according to the planned trajectory 5. In the context of the trajectory planning 55, the autonomous unit 340 uses an expected coefficient of friction for a driving situation 3 included by the trajectory 5. This expected coefficient of friction is an assumption or prediction for a coefficient of friction 9 actually existing in the driving situation 3.

In addition to the trajectory planning 55, the virtual driver 340 of the vehicle 300 shown in FIG. 1 is configured as a position regulator 346. The virtual driver 340 thus not only plans the trajectory 5, but rather additionally controls the vehicle 300 in the driving situation 3 as exactly as possible along the path 7 included by the trajectory 5. For this purpose, the virtual driver 308 actuates the drive motor, the braking system 316, and the electronically controllable steering system 4 such that the vehicle 300 follows the path 7 at a setpoint velocity included by the setpoint trajectory 5. The setpoint velocity can vary along the path 7 or represent a velocity profile.

The virtual driver 340, the steering control unit 334, a motor control unit (not shown in FIG. 1) of the drive motor, and the brake control unit 318 of the braking system 314 are connected via a vehicle network 348. To control the vehicle 300, the virtual driver 340 provides signals on the vehicle network 348 which can then be received by the other units of the vehicle 300. The vehicle network 348 is a bus system here, namely a CAN bus of the utility vehicle 300.

The active steering system 332 receives steering signals 350 provided by the virtual driver 340 and steers the vehicle 300 in accordance with these steering signals 350. For this purpose, the steering control unit 334 modulates the steering angle 8, which has a steering angle actual value 11 corresponding to the steering signals 350 provided by the virtual driver 340, with the aid of the servomotor 336 and the steering column 338 at the steered wheels 326 (the front wheels 308). Simultaneously, the virtual driver 308 also controls the longitudinal dynamics of the vehicle 300 by corresponding signals at the drive motor and the braking system 314.

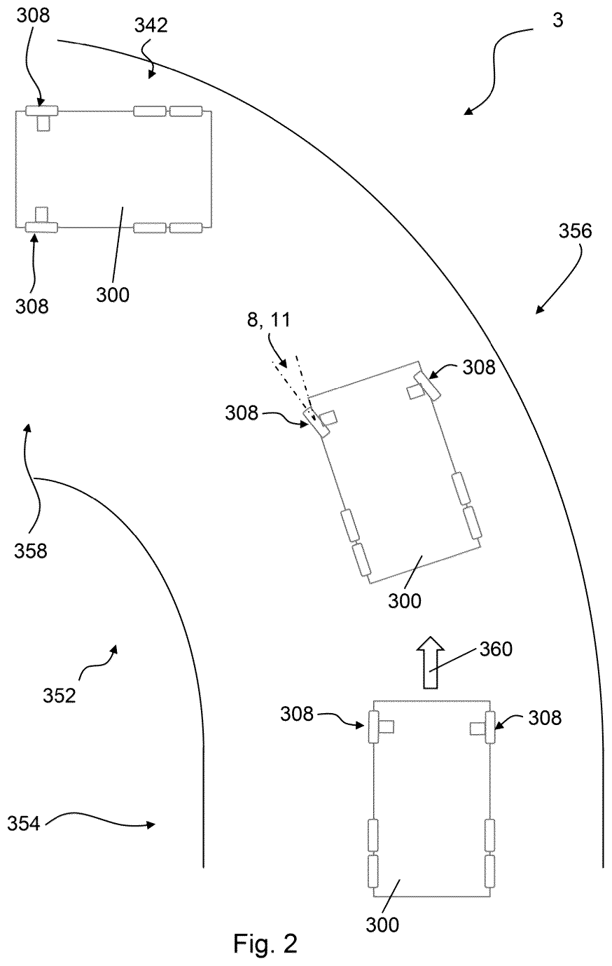

The driving situation 3 is first illustrated in FIG. 2 as a stable cornering operation of the vehicle 300 on a roadway 342 as an example. FIG. 2 shows the vehicle 300 at multiple positions in a curve 352, thus is to represent a course over time of the driving situation 3. At a curve entry 354, the front wheels 308 of the vehicle are still aligned straight, so that the steering angle 8 has a value of 0°. At a curve vertex 356, a steering angle 8 greater than 0° (in the example shown approximately) 20° is modulated at the front wheels 308 of the vehicle 300. This steering angle 8 is then reduced again in the direction of a curve exit 358, so that the front wheels 308 again have a steering angle 8 of 0° at the curve exit 358. The autonomous unit 340 specifies a steering angle 8 having a steering angle actual value 11 here, which is required to travel through the curve 352 according to a prediction performed by the autonomous unit 340. The steering angle actual value 11 of the steering angle 8 initially increases at the curve entry 354, is approximately constant in the area of the curve vertex 356, and then decreases toward the curve exit 358.

Upon entry into the curve 352, the autonomous unit 340 initially specifies the steering angle actual value 11, which corresponds to a steering angle expected value 13 that is expected for the driving situation 3. The steering angle expected value 13 is selected so that the vehicle 300 follows the curve 352 and moves within defined boundaries of the roadway 342. Furthermore, the autonomous unit 340 here also actuates the drive motor (not shown in the figures) of the vehicle 300 and the braking system 316 so that the vehicle 300 is guided at a safe velocity 360 through the curve 352 in the driving situation 3. For this purpose, the autonomous unit 340 determines beforehand the steering angle expected value 13 required for the driving situation 3 or a course over time of the steering angle expected value 13 and the velocity 360.

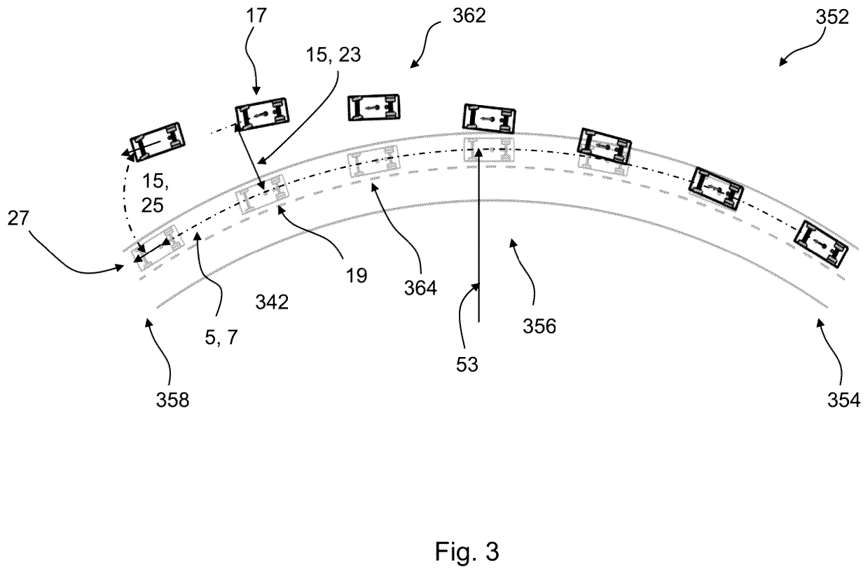

This prediction is based in the embodiment shown, among other things, on a coefficient of friction 9 between the steered wheels 326 and the roadway 342. If the real existing coefficient of friction 9 now deviates from the coefficient of friction considered in the context of determining the steering angle expected value 13, it can then be that the vehicle 300 cannot follow the curve 352. There is a significant risk of accident in this way, since the autonomous unit 340 does not suitably control the vehicle 300 under certain circumstances. For example, the autonomous unit 340 can control the vehicle 300 at greatly excessive velocity 360 in the curve 352, wherein the vehicle 300 cannot follow the course of the curve 352 under certain circumstances on a smooth roadway 342 and can be carried out of the curve 352. Such a case of a significant setpoint-actual deviation 15 between the vehicle position 17 of the vehicle 300 in the driving situation 3 (of the vehicle 300 when traveling the curve 352) and the trajectory 5 or a setpoint position 19 of the vehicle 300 in the curve 352 is illustrated in FIG. 3.

In less critical driving situations 3, the vehicle 300 can follow the curve 352 in spite of the existence of a setpoint-actual deviation 15, wherein essentially two cases can be distinguished for this purpose, which are particularly suitable for approximating the currently prevailing coefficient of friction 9. In the first case, the vehicle 300 largely follows the path 7 included by the trajectory 5. The virtual driver 340 detects a setpoint-actual deviation 15 between the vehicle position 17 and the setpoint position 19 early and compensates for it by adjusting the steering angle actual value 11. The setpoint-actual deviation 15 is negligibly small with the exception of a short period of time close to the curve entry 354. However, the actually modulated steering angle actual value 11 of the steering angle 8 is then greater or less than the steering angle expected value 13. For this case, a manipulated variable deviation 21 can thus be determined between the steering angle expected value 13 (or its course) and the steering angle actual value 11 (or its course).

In a second case, the virtual driver 340 only adjusts the steering angle 8 inadequately, so that the vehicle position 17 deviates from the trajectory 5 and additionally a manipulated variable deviation 21 nonetheless results due to the partial adjustment of the steering angle 8. In this second case, a setpoint-actual deviation 15 thus exists essentially over the entire length of the curve 352.

In the unstable cornering operation of the vehicle 300 according to FIG. 3, the vehicle 300 understeers and the setpoint-actual deviation 15 increases continuously. This unstable driving state 362 is overlaid in FIG. 3 on a vehicle 300 ideally following the path 7 in a stable driving state 364. In the stable driving state 364, the vehicle 300 is shown with lower contrast in comparison to the unstable driving state 362. Upon the entry into the curve 336, the stable driving state 364 and unstable driving state 362 are still identical. In the unstable case, the vehicle 300 cannot follow the course of the curve 352 or the path 7. With understeering, the vehicle 300 deviates toward the outside of the curve from the planned path 7 or setpoint position 19 on the path 7, which exactly corresponds to the course of the curve 352. A transverse offset 23 of the vehicle 300 in relation to the path 7 or the trajectory 5 continuously increases from the curve entry 354 to the curve exit 356. An actual yaw rate of the vehicle 300 is less than a setpoint yaw rate, so that the vehicle 300 turns less strongly into the curve 352 than desired to follow the trajectory 5. A directional error 25 between the alignment of the vehicle 300 when understeering and the stably driving vehicle 300 or a setpoint alignment 27 included by the trajectory 5 increases toward the curve exit 356. In FIG. 3, the understeering is illustrated with particularly large transverse offset 23 and particularly large directional error 25 for reasons of illustration. In less critical driving situations 3, the vehicle 300, as described above, can however follow the curve 352 in spite of the existence of a transverse offset 23 and also a directional error 18. These driving situations 3 a particularly suitable for approximating the current coefficient of friction 9. The above-describe driving situations 3, in which the vehicle substantially follows the path 7 upon the presence of a manipulated variable deviation 21, is also suitable for approximating the coefficient of friction 9.

The knowledge of the current coefficient of friction 9 is important for safe operation of the vehicle 300. If the current coefficient of friction 9 is known, the virtual driver 340 can plan the trajectory 5 accordingly and thus minimize large setpoint-actual deviations 9 between the actual vehicle position 17 and the path 7.

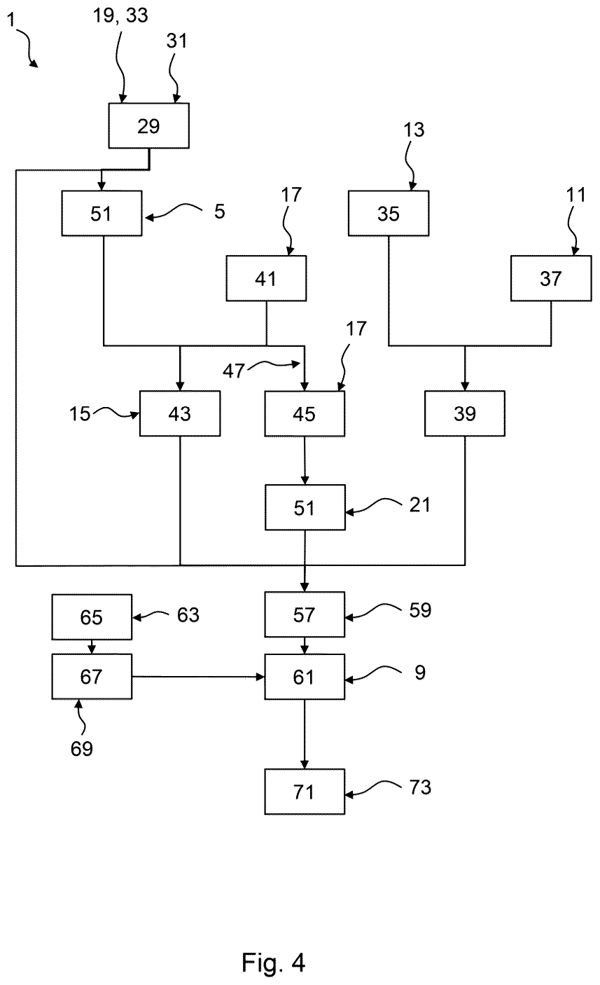

To determine the coefficient of friction 9, the vehicle 300 includes an optical sensor 370, which is configured here as a camera 372 capturing the roadway 342. However, the optical sensor 370 has the disadvantage that the coefficient of friction 9 can only be determined with sufficiently good light conditions. Therefore, in the embodiment shown, the vehicle 300 additionally includes a driver assistance system 200 which is configured to carry out a method 1 explained hereinafter with reference to FIG. 4 for approximating a coefficient of friction 9 between wheels 308, 310, 312 of the vehicle 300 and the roadway 342. The driver assistance system 200 can furthermore also verify a coefficient of friction 9 determined by the optical sensor 370. However, it is to be understood that the vehicle 300 can also only include the driver assistance system 200 and no optical sensor 370. The driver assistance system 200 includes a control unit 202 and an interface 204. The interface 204 is connected to the vehicle network 348 and also receives sensor signals 374 of the optical sensor 370 via this network, which can then be verified.

In a first step of the method 1 for approximating a current coefficient of friction 9 between the wheels 308, 310, 312 of the vehicle 300 in a current vehicle configuration 10 and the roadway 342, a load characteristic 31 of the current vehicle configuration 10 is determined 29. The current vehicle configuration 10 takes into consideration a current loading of the vehicle 300. The load characteristic 31 of the current vehicle configuration 10 is in the present embodiment a mass distribution 33 of the vehicle 300. The mass distribution 33 of the vehicle 300 also results from its loading, among other things, in addition to an intrinsic weight of the vehicle 300. The mass distribution 33 corresponds to a normal force acting in the direction of the roadway 342 on the wheels 308, 310, 312, which in turn significantly influences the maximum transmittable force in a tire contact surface of the wheels 308, 310, 312 with the roadway 342. A quality of the approximation of the coefficient of friction 9 can be improved by the consideration of the mass distribution 25. The mass distribution 25 is determined by an air suspension system (not shown in the figures) of the vehicle 300, wherein the air suspension system provides mass distribution signals 376 representing the mass distribution 33 on the vehicle network 348. The control unit 202 carries out the determination 29 of the load characteristic 31 using these mass distribution signals 376. Signals already present on the vehicle network 348 can thus advantageously be used for the determination 29. The method 1 is particularly easily implementable. However, for example, it can also be provided that the control unit 202 carries out the mass distribution 33 based on axial load signals, which are provided by the air suspension system on the vehicle network 348. The control unit 202 can preferably also take into consideration geometric characteristics of the vehicle 300 here, such as distances between the axles 302, 304, 306. It is to be understood that the method 1 can also be performed without determining 29 the load characteristic 31.

As was already explained above, the autonomous unit 340 determines the steering angle expected value 13 for the driving situation 3 and provides it in the form of expected value signals 378 on the vehicle network 348 in order to modulate a corresponding steering angle 8 via the active steering system 326. In this case, the autonomous unit 340 preferably also considers the mass distribution 33 or other load characteristics of the vehicle 300. Furthermore, the autonomous unit 340 supports the determination of the steering angle expected value 13 on an expected coefficient of friction between the wheels 308, 310, 312 of the vehicle 300 and the roadway 342. The control unit 202 of the driver assistance system 200 determines the steering angle expected value 13 using the expected value signals 378 in a further step of the method 1 (determining 35 in FIG. 4). However, it can also be provided that the control unit 202 determines the steering angle expected value 13 directly or based on the trajectory 5.

The steering angle expected value 13 is available at the control unit 202 and at the steering control unit 334. The autonomous unit 340 monitors the vehicle position 17 of the vehicle 300 during the driving situation 3 and actuates the active steering system 326 so that the vehicle 300 follows the path 7 as exactly as possible. If the coefficient of friction, based on which the steering angle expected value 13 is determined, deviates from the real coefficient of friction 9, the initial modulation of a steering angle 7 corresponding to the steering angle expected value 13 then does not result in the desired vehicle movement. As was explained above, the autonomous unit 340 attempts to adjust the steering angle actual value 11 so that the vehicle 300 is guided safely through the curve 351. The autonomous unit 340 provides actual value signals 380 corresponding to the steering angle actual value 11 on the vehicle network 348. In the case of a wet roadway 342, for example, the autonomous unit 340 increases the steering angle actual value 11 in order to keep the vehicle 300 on the roadway 342 in spite of a coefficient of friction 9 reduced in comparison to a dry roadway 342. The steering angle actual value 11 then deviates from the steering angle expected value 13.

The control unit 202 of the driver assistance system 200 receives the actual value signals 380 representing the steering angle actual value 11 and uses them for a determination 37 of the steering angle actual value 11. In the method according to FIG. 4, the determination 37 of the steering angle actual value 11 takes place chronologically after the determination 35 of the steering angle expected value 13, but in principle can also take place simultaneously with or before the determination 35. The control unit 202 then carries out a determination 39 of the manipulated variable deviation 21 using the steering angle expected value 13 and the steering angle actual value 11.

Although the autonomous unit 340 adjusts the steering angle actual value 11 to keep the vehicle 300 on the roadway 342 in the present embodiment, the vehicle position 17 nonetheless deviates from the trajectory 5. To control the vehicle 300, the autonomous unit 340 continuously monitors the current vehicle position 10 of the vehicle 300 or in extreme cases also in addition to the roadway 342. For this purpose, the autonomous unit 340 can use, for example, a GPS system of the vehicle 300. The autonomous unit 340 readjusts the steering angle actual value 11 of the vehicle 300 based on the current vehicle position 17. Furthermore, the autonomous unit 340 provides the current vehicle position 17 in the form of position signals 382 on the vehicle network 348.

The control unit 202 receives these position signals 382 from the vehicle network 348 and carries out a determination 41 of the vehicle position 17 of the vehicle 300 in the driving situation 3 based thereon. Furthermore, the autonomous unit 340 also provides the trajectory 5 on the vehicle network 348. The control unit 202 also determines, in the context of a determination 42, the trajectory 5 provided by the autonomous unit 340 on the vehicle network 348, which includes the setpoint position 19 of the vehicle 300 on the path 7. Using the trajectory 5 in the vehicle position 17, the control unit can determine the setpoint-actual deviation 15 between the vehicle position 17 and the trajectory 5 in the context of a determination 43.

The autonomous unit 340 continuously determines the vehicle position 17, so that position signals 382 are available via the vehicle network 348 which enable monitoring 45 of the setpoint-actual deviation 15. In the present embodiment, the control unit 202 of the driver assistance system 200 determines the setpoint-actual deviation 15 for multiple successive points in time 47. For example, the control unit 202 can carry out the setpoint-actual deviation 15 cyclically repeated once per second. The monitoring 45 thus permits an observation of the chronological development of the setpoint-actual deviation 15. Alternatively, it can also be provided that the setpoint-actual deviation 15 is continuously determined during the monitoring 45.

Based on the setpoint-actual deviations 9 determined during the monitoring 45, the control unit 202 determines a trajectory deviation rate of change 49 (determination 51 in FIG. 4). The trajectory deviation rate of change 43 specifies the course over time of the setpoint-actual deviation 15 and characterizes whether the setpoint-actual deviation 15 increases or decreases in the course of the driving situation 3. Increasing setpoint-actual deviations 9 or a positive trajectory deviation rate of change 49 indicate an unpredicted driving behavior of the vehicle 300. The trajectory deviation rate of change 49 is thus positive if the vehicle 300 is carried out of the curve 352 toward the outside of the curve as a result of an excessively small steering angle 8, wherein the transverse offset 23 increases over the course of time. The directional error 25 can also increase in this case. The trajectory deviation rate of change 49 can take into consideration both the transverse offset 23 and also the directional error 25. However, it can also be provided that a separate trajectory deviation rate of change 49 is determined in each case for the transverse offset 17 and the directional error 25, or that only the directional error 25 or only the transverse offset 23 is taken into consideration for the trajectory deviation rate of change 49.

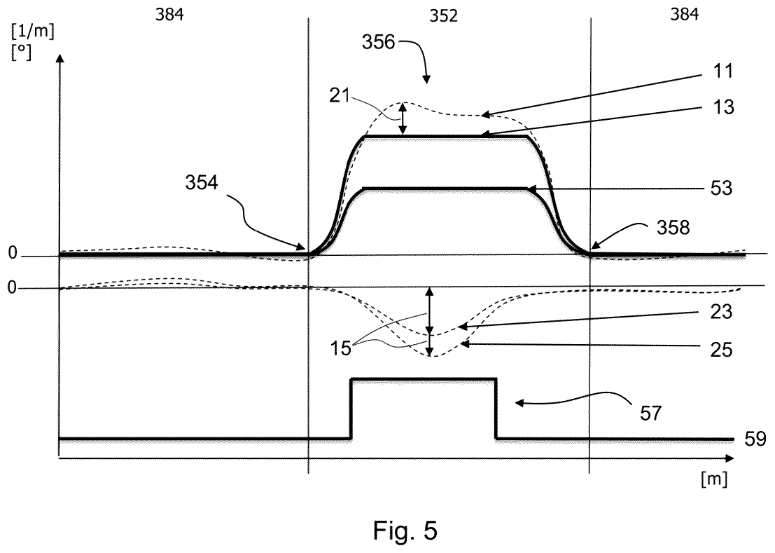

FIG. 5 illustrates a course of a curvature 53 of the path 7, the steering angle expected value 13, the steering angle actual value 11, the transverse offset 23, and the directional error 18 along the course of the curve 352 during the driving situation 3 in detail, wherein the vehicle 300 travels on a straight route section 384 in each case before and after the curve 352. The curve entry 354 and the curve exit 358 are identified in FIG. 5, wherein the curvature 53 of the path 7 or the curve 352 is equal to zero before the curve entry 354 and after the curve exit 358. In the straight route section 384 lying before the curve 352, the steering angle actual value 11 and the steering angle expected value 13 are also equal to zero. The transverse offset 23 and the directional error 25 of the vehicle 300 are also approximately zero in the straight route section 384 lying before the curve 352. Small variations of the transverse offset 23 and the directional error 18 in the straight sections 384 result from error averaging of the vehicle position 17 and possibly corrections of the autonomous unit 340. At the curve entry 354, the steering angle actual value 11 increases approximately uniformly with the steering angle expected value 13. The autonomous unit 340 modulates the steering angle actual value 11 via the active steering system 332 in order to guide the vehicle 300 along the curve 352. However, the autonomous unit 340 does not completely succeed at this in the embodiment in FIG. 5, so that a setpoint-actual deviation 15 results. This setpoint-actual deviation 15 is characterized here by the transverse offset 23, which increases starting from the curve entry 354, and the directional error 25. Since the steering angle actual value 11 corresponding to the steering angle expected value 13 is not sufficient to guide the vehicle along the path 7, the autonomous unit 340 increases the steering angle actual value 11 via the active steering system 332, so that a manipulated variable deviation 21 results. The vehicle 300 can better follow the course of the curve 352 due to the increased steering angle actual value 11 and the setpoint-actual deviation 15 between the vehicle position 17 and the path 7 of the trajectory 5 decreases again toward the curve exit 358. The steering angle actual value 11 can be reduced so that the manipulated variable deviation 21 also decreases between curve vertex 356 and curve exit 358. At the curve exit 358, the vehicle 300 is again located in the correct alignment on the path 7, so that the transverse offset 23 and the directional error 25 approximately have a value of zero.

FIG. 5 furthermore illustrates a detection 57 of a coefficient of friction deviation 59 between the coefficient of friction 9 actually existing in the driving situation 3 and the coefficient of friction which the autonomous unit 340 has used in the context of the trajectory planning 55. Following this detection 57, an approximation 61 of the current coefficient of friction 9 follows in the method 1.

After the determination 29, the determination 39, the determination 43, and the determination 51, the load characteristic 31, the manipulated variable deviation 21, the setpoint-actual deviation 15, and the trajectory deviation rate of change 49 are present at the control unit 202 of the driver assistance system 200. In the present embodiment, the control unit 202 uses these characteristic variables to approximate 61 the present coefficient of friction 9 for the driving situation 3. The approximation 61 is thus based in the embodiment shown on the load characteristic 31, the manipulated variable deviation 21, the setpoint-actual deviation 15, and the trajectory deviation rate of change 49. In cases in which the setpoint-actual deviation 15 and as a result also the trajectory deviation rate of change 49 are negligible, however, the approximation 61 can also take place, for example, only based on the manipulated variable deviation 21 and the load characteristic 31. In the approximation 61, the control unit 202 takes into consideration the size of the setpoint-actual deviation 15 and the manipulated variable deviation 21, wherein the value of the approximated coefficient of friction 9 is determined proportionally to the setpoint-actual deviation 15 and the manipulated variable deviation 21. In this case, the control unit 202 also uses the load characteristic 31 and the coefficient of friction predicted in the context of the trajectory planning 55 for the driving situation 3.

The trajectory deviation rate of change 49 is used in the present embodiment as an exclusion criterion. The approximation 61 is thus only performed here if the trajectory deviation rate of change 49 in the driving situation 3 at least temporarily characterizes an increasing setpoint-actual deviation 15. This is the case in the driving situation 3 according to FIG. 5, since the setpoint-actual deviation 15 (or the transverse offset 23 and the directional error 25) increase from the curve entry 354 to the curve vertex 356. In method 1, those driving situations 3 are therefore not considered in which a setpoint-actual deviation 15 exists, but this setpoint-actual deviation 15 already exists at the curve entry 354, for example, as a result of a preceding evasion maneuver and decreases in the course of the driving situation 3.

The coefficient of friction 9 is approximated by an adaptation of a predicted coefficient of friction 9 used in the context of the trajectory planning 55 to the load characteristic 31, the setpoint-actual deviation 15, and the manipulated variable deviation 21. However, it can also be provided in alternative embodiments that, using the load characteristic 31, the setpoint-actual deviation 15, and the manipulated variable deviation 21, a reference coefficient of friction is selected as the coefficient of friction 9 which has a reference load characteristic that lies within a load tolerance around the load characteristic 31, for which the setpoint-actual deviation 15 lies within a tolerance around a reference setpoint-actual deviation and/or for which the manipulated variable deviation 21 lies within a tolerance around a reference manipulated variable deviation.

The driver assistance system 200 is furthermore configured, based on stability signals 386 of a stability control system 388, which is an electronic stability control (ESC) of the vehicle 300 here, to detect a control system intervention 63 of the stability control system 388 (detection 65 in FIG. 4). The stability signals 386 include control system data 390 which are used in a determination 67 to determine a coefficient of friction 69 between the wheels 308, 310, 312 of the vehicle 300 and the roadway 342. The stability control system 388 carries out control system interventions 63 when the vehicle 300 is unstable. This is usually the case when sufficient forces cannot be transmitted between vehicle 300 and roadway 342, so that the coefficient of friction 69 is generally completely utilized in these driving situations 3. The control system data 390 or the stability signals 386 can advantageously be used to determine 67 the coefficient of friction 69. The approximation 61 of the coefficient of friction 9 can then be performed solely based on the coefficient of friction 69 thus determined. However, in addition to the coefficient of friction 69, preferably the setpoint-actual deviation 15, the load characteristic 31, and/or the manipulated variable deviation 21 are also used to approximate 61 the coefficient of friction 9.

In the embodiment of FIG. 1, the current coefficient of friction 9 is used following the approximation 61 to carry out 71 a following operation 73. The following operation 73 here is a provision 75 of a warning signal 77 at a warning light 392 of the vehicle 300. Furthermore, an electrical warning signal 79 is provided by the control unit 202 of the driver assistance system 200 on the vehicle network 348. The electrical warning signal 79 is thus also present at the autonomous unit 340 and can be used thereby for future trajectory planning operations 55. Furthermore, the stability control system 388 can be put into a preventative control mode 394 via the electrical warning signal 79, in which the stability control system 388 can recognize and compensate for any instabilities of the vehicle 300 early. In the present embodiment, the stability control system 388 is only put into the preventative control mode 394, however, if the present coefficient of friction 9 falls below a coefficient of friction limiting value. Stabilizing interventions of the stability control system 388 are thus usually only necessary when the current coefficient of friction 9 is comparatively low, as is the case, for example, with icy roadway 342.

The method 1 for approximating a coefficient of friction 9 was explained above for illustration on the basis of the control unit 202 of the driver assistance system 200. However, it is to be understood that the method 1 does not have to be performed by the control unit 202.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 method
3 driving situation
5 trajectory
7 path
8 steering angle
9 coefficient of friction
10 current vehicle configuration
11 steering angle actual value
13 steering angle expected value
15 setpoint-actual deviation
17 vehicle position
19 setpoint position
21 manipulated variable deviation
23 transverse offset
25 directional error
27 setpoint alignment
29 determining the load characteristic
31 load characteristic
33 mass distribution
35 determining the steering angle expected value
37 determining the steering angle actual value
39 determining the manipulated variable deviation
41 determining the vehicle position
42 determining the trajectory
43 determining the setpoint-actual deviation
45 monitoring the setpoint-actual deviation
47 point in time
49 trajectory deviation rate of change
51 determining a trajectory deviation rate of change
53 curvature
55 trajectory planning
57 detecting a coefficient of friction deviation
59 coefficient of friction deviation
61 approximating
63 control system intervention
65 detecting a control system intervention
67 determining a coefficient of friction
69 coefficient of friction
71 performing a following operation
73 following operation
75 providing a warning signal
77 warning signal
79 electrical warning signal
200 driver assistance system
202 control unit
204 interface
300 vehicle
301 utility vehicle
302 front axle
304 rear axle
306 auxiliary axle
307 direction of travel
308 front wheels
310 rear wheels
312 auxiliary wheels
314 vehicle actuators
316 braking system
318 brake control unit
320 brake modulator
322 brake actuators
324 steering system
326 steered wheels
332 active steering system
334 steering control unit
336 servomotor
338 steering column
340 autonomous unit/virtual driver
342 roadway
346 position controller
348 vehicle network
350 steering signals
352 curve
354 curve entry
356 curve vertex
358 curve exit
360 velocity
362 unstable driving state
364 stable driving state
370 optical sensor
372 camera
374 sensor signals
376 mass distribution signals
378 expected value signals
380 actual value signals
382 position signals
384 straight route section
386 stability signals
388 stability control system
390 control system data
392 warning light
394 control mode

1. A method for approximating a coefficient of friction between wheels of a vehicle in a current vehicle configuration and a roadway, the method comprising:
determining a trajectory of the vehicle for a driving situation;
determining a steering angle expected value, which is a predicted value of a steering angle to be set on the vehicle in order to follow the trajectory;
determining a steering angle actual value, which is set on the vehicle in the driving situation;
determining a vehicle position of the vehicle in the driving situation;
determining at least one of a manipulated variable deviation between the steering angle expected value and the steering angle actual value and a setpoint-actual deviation between the vehicle position during the driving situation and the trajectory; and, approximating the coefficient of friction based on the determined at least one of the manipulated variable deviation and the determined setpoint-actual deviation.

2. The method of claim 1, wherein the setpoint-actual deviation is or includes a transverse offset of the vehicle from a path included in the trajectory.

3. The method of claim 1, wherein the setpoint-actual deviation is or includes a directional error of the vehicle in relation to a setpoint alignment of the vehicle included in the trajectory.

4. The method of claim 1, wherein the coefficient of friction is only approximated if both the manipulated variable deviation and the setpoint-actual deviation are present.

5. The method of claim 1 further comprising performing a trajectory planning to obtain the trajectory.

6. The method of claim 1, further comprising determining at least one load characteristic of the current vehicle configuration.

7. The method of claim 6, wherein said determining the steering angle expected value is performed using the at least one load characteristic.

8. The method of claim 1, wherein the steering angle expected value is determined based on at least one of a curvature of the trajectory and a wheelbase of the vehicle, a number of axles of the vehicle, and a steerability of axles of the vehicle.

9. The method of claim 1 further comprising:
monitoring the setpoint-actual deviation, wherein the setpoint-actual deviation is continuously determined or is determined at multiple successive points in time during the monitoring; and,
determining a trajectory deviation rate of change based on the setpoint-actual deviations determined during the monitoring.

10. The method of claim 9, wherein said approximating the coefficient of friction only takes place if the trajectory deviation rate of change characterizes an increasing setpoint-actual deviation of the vehicle position from the trajectory.

11. The method of claim 1, wherein said approximating the coefficient of friction takes place using a learned reference coefficient of friction.

12. The method of claim 1 further comprising:
detecting a control system intervention of a stability control system of the vehicle;
determining a coefficient of friction using control system data provided by the stability control system; and,
wherein the approximation of the coefficient of friction is alternatively or additionally performed based on the coefficient of friction if a control system intervention is detected.

13. The method of claim 1 further comprising:
performing at least one following operation using the approximated coefficient of friction; and,
wherein the following operation is or includes at least one of providing a warning signal, putting a stability control system into a preventative control mode, redetermining the trajectory of the vehicle, determining a movement degree of freedom limiting value, limiting a movement degree of freedom of the vehicle, and validating a coefficient of friction sensor.

14. The method of claim 13, wherein the following operation is only performed if the approximated coefficient of friction falls below a coefficient of friction limiting value.

15. A driver assistance system for a vehicle, which is configured to carry out the method of claim 1.

16. A vehicle comprising:
at least two axles;
an autonomous unit;
a steering system;
a driver assistance system including a non-transitory computer readable medium having program code stored thereon for approximating a coefficient of friction between wheels of the vehicle in a current vehicle configuration and a roadway;
said program code being configured, when executed by a processor, to:
determine a trajectory of the vehicle for a driving situation;
determine a steering angle expected value, which is a predicted value of a steering angle to be set on the vehicle in order to follow the trajectory;
determine a steering angle actual value, which is set on the vehicle in the driving situation;
determine a vehicle position of the vehicle in the driving situation;
determine at least one of a manipulated variable deviation between the steering angle expected value and the steering angle actual value and a setpoint-actual deviation between the vehicle position during the driving situation and the trajectory; and,
approximate the coefficient of friction based on the determined at least one of the manipulated variable deviation and the determined setpoint-actual deviation.

17. A computer program product comprising:
program code for approximating a coefficient of friction between wheels of a vehicle in a current vehicle configuration and a roadway, wherein said program code is stored on a non-transitory computer-readable medium;
said program code being configured, when executed by a processor, to:
determine a trajectory of the vehicle for a driving situation;
determine a steering angle expected value, which is a predicted value of a steering angle to be set on the vehicle in order to follow the trajectory;
determine a steering angle actual value, which is set on the vehicle in the driving situation;
determine a vehicle position of the vehicle in the driving situation;
determine at least one of a manipulated variable deviation between the steering angle expected value and the steering angle actual value and a setpoint-actual deviation between the vehicle position during the driving situation and the trajectory; and,
approximate the coefficient of friction based on the determined at least one of the manipulated variable deviation and the determined setpoint-actual deviation.
